(19) United States
(12) Patent Application Publication
(10) Pub. No.: US 2019/0385389 A1
(43) Pub. Date: Dec. 19, 2019

(54) METHOD AND APPARATUS FOR CHECKING A DISPLAY UNIT FOR A VEHICLE, AND DISPLAY UNIT FOR A VEHICLE

(71) Applicant: ZF Friedrichshafen AG, Friedrichshafen (DE)

(72) Inventors: Vitali FRIBUS, Quakenbrück (DE); Andreas PEUKERT, Barnstorf (DE); Joachim SPRATTE, Osnabrueck (DE); Johannes KIRCHHOFF, Colnrade (DE)

(73) Assignee: ZF Friedrichshafen AG, Friedrichshafen (DE)

(21) Appl. No.: 16/479,166

(22) PCT Filed: Dec. 18, 2017
(86) PCT No.: PCT/EP2017/083231

§ 371 Date: Jul. 18, 2019

(30) Foreign Application Priority Data
Jan. 20, 2017 (DE) 10 2017 200 895.4

(51) Int. Cl. G07C 5/08; G09G 3/34; G01J 1/44

(52) U.S. Cl. CPC G07C 5/0808; G09G 3/3406; G01J 1/44; G01J 2001/4247; G09G 2360/145; G09G 2380/10; G09G 2320/10; G09G 2330/12

(57) ABSTRACT

The present disclosure relates to a method for checking a display unit for a vehicle, wherein the display unit comprises a display matrix that has numerous pixels that can be backlit, and a detector unit for detecting light reflected by pixels when they are backlit. A gear step signal that represents a current gear step of the vehicle is input. The pixels are then actuated using the gear step signal, to display at least one test image on the display unit. The detector unit is read in response to the actuation in order to obtain at least one test signal assigned to the test image. This is then evaluated in order to check the functional operability of the display unit.

### RELATED APPLICATIONS

This application is a filing under 35 U.S.C. § 371 of International Patent Application PCT/EP2017/083231, filed Dec. 18, 2017, and claiming priority to German Patent Application 10 2017 200 895.4, filed Jan. 20, 2017. All applications listed in this paragraph are hereby incorporated by reference in their entireties.

### TECHNICAL FIELD

The present disclosure relates to a method and an apparatus for checking a display unit for a vehicle, a corresponding computer program, and a display unit for a vehicle.

### BACKGROUND

Modern vehicles can be equipped with a display serving as a central component of human-machine interface for visualizing an infotainment and comfort function or safety-related information, e.g. gear steps.

In order to ensure the functional reliability of such a display system and satisfy legal or customer-specific safety requirements, it is necessary to continuously check the display system.

### SUMMARY

Based on this, the present disclosure provides an improved method for checking a display unit for a vehicle, a corresponding apparatus, and an improved display unit. Advantageous designs can also be derived from the following description.

A method for checking a display unit for a vehicle is presented, wherein the display unit contains a display matrix that has numerous pixels that can be backlit, and a detector unit for detecting reflected light when the pixels are backlit, wherein the method comprises the following steps:

inputting a gear step signal representing the current gear step of the vehicle;

actuating the pixel or pixels with the gear step signal to display at least one test image on the display unit;

reading the detector unit in response to the actuation in order to obtain at least one test signal relating to the test image; and

evaluating the test signal in order to check the display unit.

A display unit can be a monitor for displaying information. A display matrix can be an optical display comprising numerous individual pixels, also referred to as image points, such as a liquid crystal display. The pixels can be arranged in horizontal lines and vertical columns, for example, and composed of at least two sub-pixels of different colors, for example, depending on the embodiment. Each pixel can be discretely defined by a line and column number. The display matrix can be a photodiode, a phototransistor, or some other type of light-sensitive component for generating a photocurrent. By way of example, the detector unit can also comprise numerous such light-sensitive components. A lighting unit can be a light emitting diode or some other suitable light source. By way of example, the lighting unit can also comprise numerous such light sources.

A gear step is a setting P, D, N, or R of an automatic transmission. A test image is an image that is displayed in order to check the functional operability of the display unit. By way of example, the test image can represent a specific test pattern, or it can be a black image.

The approach described herein is based on the knowledge that the functional operability of a display unit for displaying a gear step in a vehicle, in conjunction with a shift-by-wire application, can be inexpensively and reliably checked in that a test image is displayed on the display unit, a light reflection generated in the display unit when displaying the test image is detected by a detector unit located in the display unit, and evaluated appropriately. By way of example, the test image can be generated with each shifting of the gear steps, or it can be generated continuously when the display unit is in operation. In this manner, it can be ensured that safety-relevant information, such as image data relating to the current gear step, is reliably displayed on the display unit.

According to one embodiment, the pixel or pixels can be actuated in the actuating step in order to display a gear step image relating to the current gear step on the display, after displaying the test image. A gear step image can be a symbol that represents the gear step, or a letter that represents the gear step. As a result, it can already be ensured that the display unit is functioning correctly before displaying the gear step image.

According to another embodiment, the pixel or pixels can be actuated in the actuation step in order to display the test image and the gear step image in an image sequence determined as a function of the current gear step. The detector unit can be read in the reading step in order to obtain a sequence of test signals corresponding to the image sequence. Accordingly, the sequence of test signals can be processed in the evaluation step in order to check the display unit. By way of example, the test image and the gear step image can be displayed in an alternating sequence when the display unit is in operation for respective specific display periods. The display period for the test image and the display period for the gear step image can be different. By way of example, the display period for the test image can be shorter than the display period for the gear step image. The reliability of the method can be improved with this embodiment.

It is advantageous when the pixel or pixels are actuated in the actuation step to display the test image and the gear step image with different refresh rates. By way of example, the test image can be displayed such that it is not noticed by a viewer of the display unit. As a result, disruptive negative impacts to the image can be avoided when checking the display unit.

It is also advantageous when the pixel is actuated in the actuation step such that it displays the test image and the gear step image in an alternating sequence. As a result, the display unit can be checked on a continuous basis.

In addition, the pixel can be actuated in the actuation step to display the test image in response to a shifting of the current gear step. As a result, display errors can be avoided when shifting gear steps.

According to another embodiment, the pixels can be actuated in the actuation step to display the test image for a maximum of 0.1 seconds. As a result, the test image is not noticed by a viewer of the display unit.

The approach presented herein also results in a device that is designed to execute, actuate, or implement the steps of a variation on the method presented herein in corresponding devices. The fundamental problem addressed by the present disclosure can also be quickly and efficiently solved with this embodiment variation in the form of an apparatus.

For this, the apparatus can contain at least one computer unit for evaluating signals or data, at least one memory for storing signals or data, at least one interface to a sensor or an actuator for inputting sensor signals from the sensor, or for outputting data or control signals to the actuator, and/or at least one communication interface for inputting or outputting data embedded in a communication protocol. The computer unit can be a signal processor, a microcontroller, etc., wherein the memory can be a flash drive, an EPROM, or a magnetic memory. The communication interface can be configured to input and output data in a wireless and/or hardwired manner, wherein the communication interface can input or output data in a hardwired manner, input these data from a corresponding data transfer line, e.g. electrically or optically, or output these data in a corresponding data transfer line.

An apparatus can be an electric device in the present case, that processes sensor signals and outputs control and/or data signals as a result. The apparatus can have an interface in the form of hardware and/or software. With a hardware design, the interfaces can be part of a so-called system ASIC containing various functions of the apparatus. The interfaces can also be discrete integrated circuits, or they can be composed at least in part of discrete components. With a software design, the interfaces can be software modules present on a microcontroller along with other software modules.

In an advantageous design, the apparatus controls the vehicle. The apparatus can access sensor signals, e.g. acceleration, pressure, steering angle, or environmental signals for this. The actuation takes place via actuators such as braking or steering actuators, or a vehicle motor control device.

The approach to the problem addressed herein also results in a display unit for a vehicle, wherein the display unit has the following features:

a display matrix with numerous pixels that can be backlit;

a lighting unit for backlighting the pixels;

a detector unit for detecting light reflected when the pixels are backlit; and

an apparatus according to any of the embodiments described above.

Safety requirements with regard to the Automotive Safety Integrity Level are satisfied with such a display unit.

According to one embodiment, the display unit can contain a reflector element for reflecting the light reflected onto the detector unit when the pixel or pixels are backlit, or it can contain, additionally or alternatively, a diffusor element for diffusing light emitted from the lighting unit. In particular, the pixels can be on the diffusor element. A reflector element and a diffusor element can be a plate-shaped optical component, for example. The reflector element can be placed behind the display unit, on the back thereof, for example, in order to deflect the light reflected by the pixels toward the detector unit. With this embodiment, the light reflected by the pixels can be deflected in a targeted manner toward the detector unit, and a uniform light distribution can also be obtained in the display unit.

The reflector element and the diffusor element can be located opposite one another according to another embodiment. In particular, the detector unit or, additionally or alternatively, the lighting unit can be placed between the reflector element and the diffusor element. This results in a very compact construction of the display unit. Furthermore, light intensity losses can also be minimized.

The detector unit and the lighting unit can be located opposite one another according to another embodiment. This also results in a very compact construction of the display unit.

A computer program product or computer program that contains program code that can be stored on a machine-readable carrier or memory unit, e.g. a semiconductor memory, a disk memory, or an optical memory, and can be used for executing, implementing, and/or actuating the steps of the method according to any of the embodiments described above, is also advantageous, particularly when the program product or the program is executed on a computer or a device. An apparatus that contains units configured to execute and/or actuate the method according to any of the preceding claims.

### BRIEF DESCRIPTION OF THE DRAWINGS

The present disclosure shall be explained in greater detail with reference to the attached drawings.

FIG. 1 shows a schematic illustration of a display unit according to an exemplary embodiment;

FIG. 2 shows a schematic illustration of a signal flow when checking a display unit according to an exemplary embodiment;

FIG. 3 shows a diagram illustrating an image sequence on a display unit according to an exemplary embodiment;

FIG. 4 shows a diagram illustrating an image sequence on a display unit according to an exemplary embodiment;

FIG. 5 shows a diagram illustrating an image sequence on a display unit according to an exemplary embodiment;

FIG. 6 shows a schematic illustration of an apparatus according to an exemplary embodiment; and

FIG. 7 shows a flow chart for a method according to an exemplary embodiment.

### DETAILED DESCRIPTION

In the following description of exemplary embodiments, identical or similar reference symbols are used for the elements shown in the various figures that have similar functions, wherein there shall be no repetition of the descriptions of these elements.

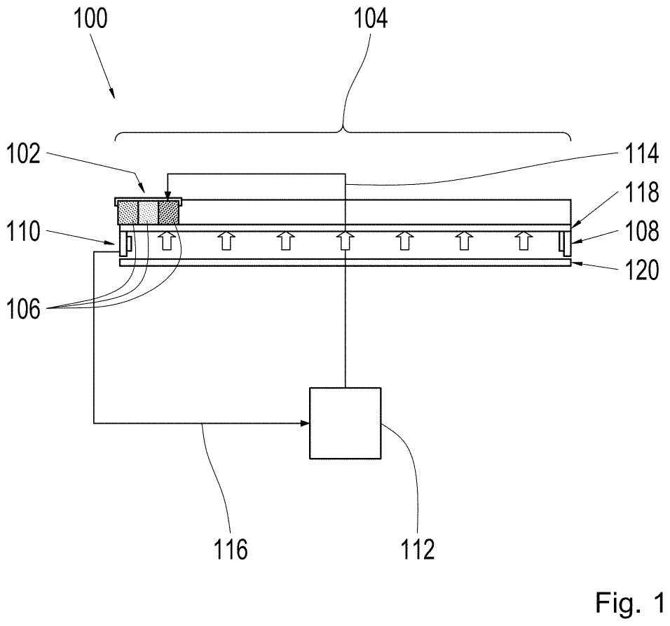

FIG. 1 shows a schematic illustration of a display unit 100 according to an exemplary embodiment. The display unit 100 for displaying image data regarding a gear step of a vehicle, in this case a liquid crystal display unit, comprises numerous pixels 102 arranged in a display matrix 104. For purposes of clarity, just one of the pixels 102 is shown in FIG. 1. The pixels 102 are RGB pixels, each of which contains three sub-pixels according to this exemplary embodiment, wherein the sub-pixels 106 are configured to each represent one color, in this case the colors red, green and blue. Depending on the exemplary embodiment, the pixels 102 can also comprise more or fewer than three sub-pixels, and represent different grey scales, instead of colors. The display unit 100 also comprises a lighting unit 108 for backlighting the pixels 102. The lighting unit 108 is a light emitting diode, or an array of numerous light emitting diodes, for example. The display unit 100 also comprises a detector unit 110, e.g. one or more photodiodes. The detector unit 110 is configured to detect light that is deflected back to the display unit 100 by pixels 102 when the pixels 102 are backlit.

The detector unit 110 and the pixels 102 are connected to an apparatus 112 for checking the functional operability of the display unit 100. The apparatus 112 is configured, e.g. to obtain information from a shift-by-wire system of the vehicle regarding a current gear step, and to process this information for actuating the pixels 102. For this, the apparatus 112 outputs a corresponding actuation signal 114 to the pixels 102. The pixels 102 are actuated by the actuation signal 114 in order to display a test image for checking the functional operability on the display unit 100, e.g. a special test pattern. Alternatively, the apparatus 112 deactivates the pixels 102 by means of the actuation signal 14, such that a black image is displayed. The apparatus 112 reads the detector unit 110 in response to the actuation of the pixels 102 for generating the test image in order to obtain a test signal 116 that represents a photocurrent generated by the reflection of light on the pixels 102. The apparatus 112 than checks whether the display unit 100 correctly displays the test image by means of the test signal 116.

According to this exemplary embodiment, the display unit 100 comprises a diffusor element 118, in this case in the form of a light-diffusing plate, on which the pixels 102 are arranged, e.g. in lines and columns, thus forming the display matrix 104. There is a likewise plate-shaped reflector element 120 opposite the diffusor element 118, which is configured to deflect the light reflected by the pixels 102 toward the detector unit 110. The reflector unit 120 is connected to the diffusor element 118, e.g. via the lighting unit 108 and the detector unit 110, such that the lighting unit 108 and the detector unit are located between the diffusor element 118 and the reflector element 120. The lighting unit 108 and the detector unit 110 are basically located at opposite ends of the diffusor element 118 and the reflector element 120.

According to one exemplary embodiment, the display unit 100 comprises a backlighting composed of LEDs, the reflector and diffusor, by means of which all of the pixels 102 are illuminated in a uniform manner. A pixel 102 is comprised of three sub-pixels 106, for example, each of which has a different color filter for the primary colors red, green and blue. Each sub-pixel 106 can be actuated individually, and thus functions as a type of light valve, through which the brightness of the individual colors can be affected. If, for example, a white image is displayed on the display unit 100, then all of the light valves of the sub-pixels 106 are open as wide as possible, such that the display unit 100 emits light with the maximum brightness. If instead a black image is displayed, all of the light valves are closed, and the light of the backlighting is reflected by the sub-pixels 106.

This reflected light of the sub-pixels 106 is detected by a photodiode between the diffusor and the reflector, and used for monitoring the functional operability of the sub-pixels 106, or the display unit 100, in the appropriate manner. For this, the standard hardware architecture of the backlighting for the display unit 100, for example, an LED backlight of an LCD display, is expanded, for example, with a photodiode and an additional signal line, leading from the photodiode to a control unit, e.g. a shift-by-wire system.

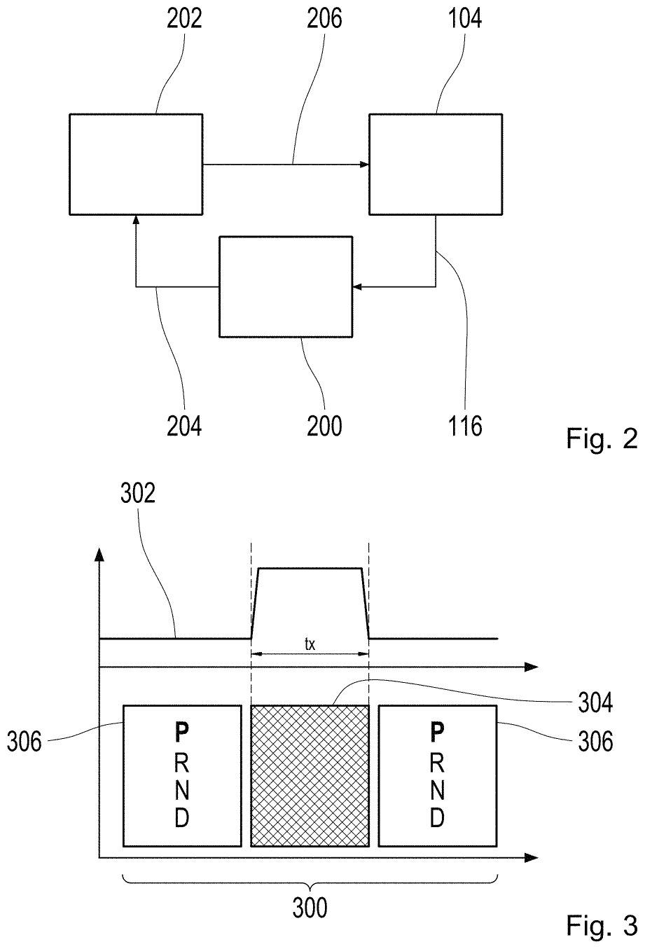

FIG. 2 shows a schematic illustration of a signal flow when checking a display unit according to an exemplary embodiment, basically a display unit such as is described above in reference to FIG. 1. The display matrix 104 functioning as a display, a shift-by-wire system 200, and a display controller 202 are shown therein. The shift-by-wire system 200 and the display controller 202 can be components, for example, of the apparatus for checking the display unit described above in reference to FIG. 1. The shift-by-wire system 200 sends the information regarding the current gear step, in the form of a gear step signal 204, indicating the gear steps P, R, N, or D, for example, to the display controller 202, which assigns corresponding image data 206 to this information, and conveys this to the display matrix 104 with a defined image frequency. The shift-by-wire system 200 then receives the test signal 116, e.g. a signal from a photodiode, from the display matrix 104.

FIG. 3 shows a diagram illustrating an image sequence 300 on a display unit according to an exemplary embodiment. This shows the temporal course of a photocurrent 302 detected by the detector unit. The photocurrent 302 corresponds to the test signal output by the detector unit, for example. It should be noted that the photocurrent 302 is a black image here, by way of example, during a time period tx, in which the test image 304 is displayed on the display unit, which increases abruptly to a constant value. A gear step image 306 that represents the current gear step, in this case a gear step P, by way of example, is displayed on the display unit prior to and following the time period tx. By way of example, the text image 304 is shown briefly while shifting between gear steps, between two separate gear step images 306.

By way of example, the test image 304 is shown for a short time period tx after each gear step shifting, which cannot be detected by the human eye. The time period tx is a maximum of 0.1 seconds, for example. The light reflected at the sub-pixels is sensed by the shift-by-wire system by means of a detector unit, e.g. a photodiode. In this manner, the general functional operability of the display unit can be checked, and errors such as a screen freeze can be detected immediately.

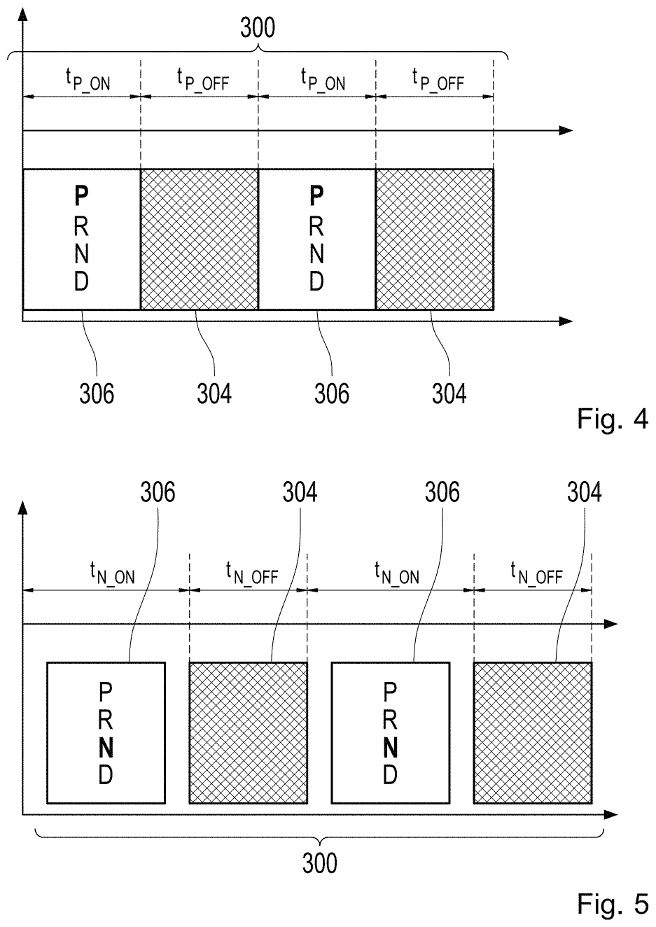

FIG. 4 shows a diagram illustrating an image sequence 300 on a display unit according to an exemplary embodiment. In differing from FIG. 3, the image sequence 300 shown in FIG. 4 comprises more than one test image 304, in this case two test images 304, by way of example. As is shown in FIG. 4, the gear step images 304 are displayed for a time period t_{P_on}, and the test images 304 are shown, in an alternating sequence therewith, for a time period t_{P_off} during the image sequence 300, wherein the pixels of the display unit in the time period t_{P_off} are deactivated. The two time periods t_{P_on}, t_{P_off} can be the same length, as shown in FIG. 4, or have different lengths, as shown in FIG. 5, depending on the exemplary embodiment. The image sequence 300, i.e. the respective display periods of the gear step image 306 and the test image 304 are determined, for example, depending on the gear step that is to be displayed.

FIG. 5 shows a diagram illustrating an image sequence 300 on a display unit according to an exemplary embodiment. In a different manner from FIG. 4, the gear step image 306 represents a neutral setting N in this case. In order to distinguish it from the image sequence assigned to the park setting P, a time period t_{N_on} for the gear step image 306 representing the neutral setting N is significantly longer than the time period t_{p_on} shown in FIG. 4. The test image 304 is generated in this case for a time period t_{N_off}.

By way of example, each gear step is assigned a unique imaging sequence between the respective gear step image 304 and a black image serving as the test image 306. The temporal evaluation of the depicted test images 306 by means of the detector unit then allows for a unique conclusion to be drawn regarding the respective image sequence, and thus the gear step, such that display errors, such as a screen freeze, can be reliably detected.

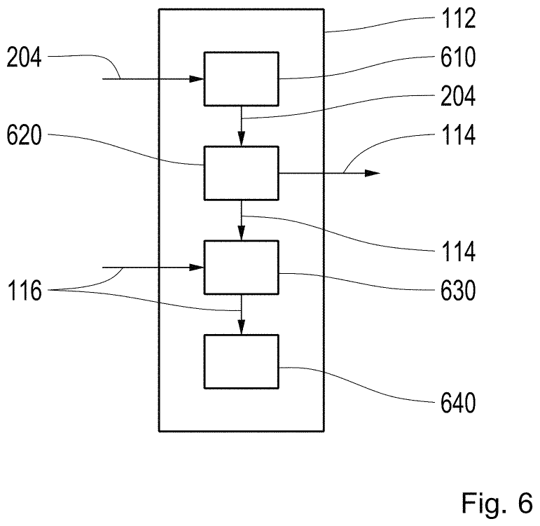

FIG. 6 shows a schematic illustration of an apparatus 112 according to an exemplary embodiment, e.g. an apparatus such as that described above in reference to FIGS. 1 and 2. The apparatus 112 comprises an input unit 610 for inputting gear step signals 204, and an actuation unit 620, which receives the gear step signal 204 from the input element 610, and uses it to output the actuation signal 114 for displaying a test image on a display unit. An output unit 630 is configured to read the detector unit in response to the actuation signal 114. The output unit 630 receives the test signal 116, and then conveys it to an evaluation unit 640, which is configured to check the functional operability of the display unit based on the test signal 116.

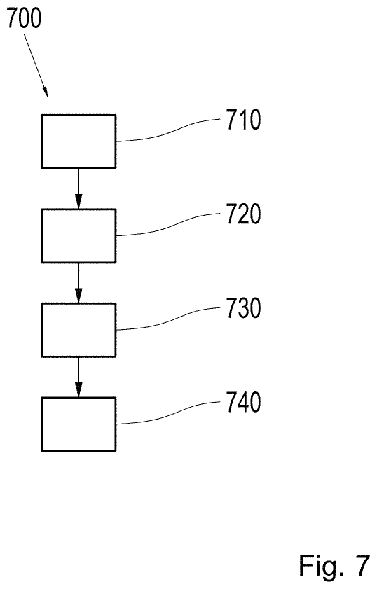

FIG. 7 shows a flow chart for a method 700 for checking a display unit according to an exemplary embodiment. The method 700 can be executed with the use of an apparatus such as that described above in reference to FIG. 1, 2 or 6. The gear step signal is input in step 710. The pixels of the display unit are then actuated in step 720 using the gear step signal, in order to display the test image. The detector is read in Step 730 in response to the actuation of the pixels, in order to obtain the test signal. Lastly, the test signal is evaluated in step 740 in the appropriate manner, in order to determine whether the display unit correctly displays the test image.

The steps of the method 700 can be executed on a continuous basis, for example, in order to continuously check the display unit during operation.

The exemplary embodiments described herein and shown in the figures are selected merely by way of example. Different exemplary embodiments can be combined with one another in their entirety, or with regard to individual features. An exemplary embodiment can also be supplemented by features of another exemplary embodiment. Furthermore, the steps of the method can be repeated or executed in a different sequence than that provided in the description.

If an exemplary embodiment comprises and “and/or” conjunction between a first feature and a second feature, this can be read to mean that the exemplary embodiment according to one embodiment contains both the first feature and the second feature, and according to another embodiment contains either just the first feature or just the second feature.

### REFERENCE SYMBOLS

100 display unit
102 pixel
104 display matrix
106 sub-pixel
108 lighting unit
110 detector unit
112 apparatus for checking the display unit
114 actuation signal
116 test signal
118 diffusor element
120 reflector element
200 shift-by-wire system
202 display controller
204 gear step signal
206 image data
300 image sequence
302 photocurrent
304 test image
306 gear step image
610 input unit
620 actuation unit
630 output unit
640 evaluation unit
700 method for checking the display unit
710 input step
720 actuation step
730 output step
740 evaluation step

1. A method for checking a display unit for a vehicle, wherein the display unit comprises a display matrix including a plurality of pixels configured to be backlit, and a detector unit configured to detect light reflected when the pixels are backlit, wherein the method comprises:
inputting a gear step signal that represents a current gear step of the vehicle;
actuating the pixels using the gear step signal to display at least one test image on the display unit;
reading the detector unit in response to actuating the pixels to obtain at least one test signal assigned to the test image; and
evaluating the test signal to check the display unit.

2. The method according to claim 1, wherein the pixels are actuated to display a gear step image assigned to the current gear step on the display unit after displaying the test image.

3. The method according to claim 2, wherein the pixels are actuated to display the test image and the gear step image on the display unit in an image sequence determined on a basis of the current gear step,
wherein the detector unit is read to obtain a test signal sequence corresponding to the image sequence, and
wherein the test signal sequence is processed to check the display unit.

4. The method according to claim 2 wherein the pixels are actuated to display the test image and the gear step image at different refresh rates.

5. The method according to claim 2, wherein the pixels are actuated to display the test image and the gear step image in an alternating sequence.

6. The method according to claim 1, wherein the pixels are deactivated to display a black image as the test image.

7. The method according to claim 1, wherein the pixels are actuated to display the test image in response to a shifting of the current gear step.

8. The method according to claim 1, wherein the pixels are actuated to display the test image for a time period of less than or equal to 0.1 seconds.

9. (canceled)

10. A display unit for a vehicle comprising:
a display matrix comprising a plurality of pixels that can be backlit;
a lighting unit configured to backlight the plurality of pixels;
a detector unit configured to detect light reflected when the pixels are backlit;
an input unit configured to input a gear step signal that represents a current gear step of the vehicle;
an actuation unit configured to actuate the plurality of pixels using the gear step signal to display at least one test image on the display matrix;
an output unit configured to read the detector unit in response to the actuation unit actuating the plurality of pixels to obtain at least one test signal assigned to the test image; and
an evaluation unit configured to evaluate the test signal to check the display unit.

11. The display unit according to claim 10, further comprising:
a reflector element configured to reflect the light reflected when the pixels are backlit toward the detector unit.

12. The display unit according to claim 22, wherein the reflector element and the diffusor element are opposite one another, and wherein at least one of the detector unit or the lighting unit is located between the reflector element and the diffusor element.

13. The display unit according to claim 10, wherein the detector unit and the lighting unit are opposite one another.

14. (canceled)

15. A machine-readable memory storing thereon a computer program that, when executed by a computing device of a vehicle, causes the computing device to perform a method comprising:
inputting a gear step signal that represents a current gear step of the vehicle;
actuating pixels of a display unit using the gear step signal to display at least one test image on the display unit, the display unit comprising a display matrix including a plurality of pixels configured to be backlit;
reading a detector unit configured to detect light reflected when the pixels are backlit in response to actuating the pixels to obtain at least one test signal assigned to the test image; and
evaluating the test signal to check the display unit.

16. The display unit according to claim 10, wherein the actuation unit is further configured to actuate the pixels to display a gear step image assigned to the current gear step on the display unit after displaying the test image.

17. The display unit according to claim 16, wherein the actuation unit is further configured to actuate the pixels to display the test image and the gear step image on the display unit in an image sequence determined on a basis of the current gear step,
wherein the output unit is further configured to read the detector unit to obtain a test signal sequence corresponding to the image sequence, and
wherein the evaluation unit is further configured to process the test signal sequence to check the display unit.

18. The display unit according to claim 16, wherein the actuation unit is further configured to actuate the pixels to display the test image and the gear step image at different refresh rates.

19. The display unit according to claim 16, wherein the actuation unit is further configured to actuate the pixels to display the test image and the gear step image in an alternating sequence.

20. The display unit according to claim 16, wherein the actuation unit is further configured to deactivate the pixels to display a black image as the test image.

21. The display unit according to claim 10, wherein the actuation unit is further configured to actuate the pixels to display the test image in response to a shifting of the current gear step.

22. The display unit according to claim 11, further comprising:
a diffusor element for diffusing light emitted by the lighting unit, wherein the pixels are located on the diffusor element.
